(19) United States
(12) Patent Application Publication
(10) Pub. No.: US 2025/0276481 A1
(43) Pub. Date: Sep. 4, 2025

(54) FRICTION EXTRUSION OF POLYMER COMPOSITES WITH HIGH FILLER CONTENT

(71) Applicant: Battelle Memorial Institute, RIchland, WA (US)

(72) Inventors: Keerti S. Kappagantula, West Richland, WA (US); Md. Reza-E-Rabby, West Richland, WA (US); Aditya K. Nittala, Richland, WA (US); Jose Luis Ramos, Kennewick, WA (US); Yelin Ni, Austin, TX (US); Satish K. Nune, RIchland, WA (US); David J. Heldebrant, Richland, WA (US)

(21) Appl. No.: 18/806,408

(22) Filed: Aug. 15, 2024

Related U.S. Application Data
(60) Provisional application No. 63/532,967, filed on Aug. 16, 2023.

(51) Int. Cl. B29C 48/00; B29C 48/30; B29C 48/36; B29K 23/00; B29K 105/16; B29K 507/04; B29K 511/14

(52) U.S. Cl. CPC B29C 48/022; B29C 48/30; B29C 48/361; B29K 2023/0633; B29K 2023/065; B29K 2023/12; B29K 2023/14; B29K 2105/167; B29K 2507/04; B29K 2511/14

(57) ABSTRACT

An extruded polymer composite may include a polymer matrix. An extruded polymer composite may include and a filler content greater than about 65 wt % homogenously distributed about the polymer matrix.

### CROSS-REFERENCE TO RELATED APPLICATION

This application claims the benefit of priority to U.S. Provisional Patent Application Ser. No. 63/532,967 entitled “FRICTION EXTRUSION OF POLYMER COMPOSITES WITH HIGH FILLER CONTENT,” filed Aug. 16, 2023, the disclosure of which is incorporated herein in its entirety by reference.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND

Polymer composites with high filler content offer enhanced mechanical properties and potential cost savings compared to traditional polymer composite materials. However, manufacturing such composites has historically been challenging due to issues like poor filler dispersion, increased viscosity, and processing difficulties at high filler loadings. Conventional extrusion methods often struggle to achieve homogeneous filler distribution above certain filler content thresholds.

### SUMMARY OF THE INVENTION

In some aspects, the techniques described herein relate to an extruded polymer composite including: a polymer matrix; and a filler content greater than about 65 wt % homogenously distributed about the polymer matrix.

In some aspects, the techniques described herein relate to a method for manufacturing a polymer composite, the method including: introducing a feedstock including a mixture of a polymer component and a filler component into a container; and establishing an axial force and a rotational force at a face of a die engaged with the feedstock to establish shear to homogenize the mixture including heating the feedstock locally, and simultaneously distributing the filler homogeneously within a matrix of the polymer component.

In some aspects, the techniques described herein relate to a die for use in manufacturing an extruded polymer composite, the die including: a body defining a face configured to engage a polymer composite feedstock including a mixture of polymer and filler, the body including: a neck section defining a passage from an opening in the die face through which plasticized polymer composite feedstock is extruded, to a landing section that defines a cross sectional profile of the extruded polymer composite; and a release section, wherein a cross-sectional width or diameter of the landing section is less than a cross-sectional width or diameter of the release section in the same axis.

### BRIEF DESCRIPTION OF THE FIGURES

The drawings illustrate generally, by way of example, but not by way of limitation, various aspects of the present invention.

FIG. 1 is sectional view of a Shear Assisted Processing and Extrusion system.

FIG. 2 is a sectional view of a die of the Shear Assisted Processing and Extrusion system of FIG. 1.

FIG. 3A is a top view of a die face of a die according to the Examples.

FIG. 3B is a sectional view of the die of FIG. 3A.

FIG. 4A is a top view of a die face of another die according to the Examples.

FIG. 4B is a sectional view of the die of FIG. 4A.

FIG. 5A is a top view of a die face of another die according to the Examples.

FIG. 5B is a sectional view of the die of FIG. 5A.

FIG. 6A is a top view of a die face of another die according to the Examples.

FIG. 6B is a sectional view of the die of FIG. 6A.

FIG. 7A is a top view of a die face of another die according to the Examples.

FIG. 7B is a sectional view of the die of FIG. 7A.

FIG. 8 is a graph showing a measured extrusion system temperature versus the position of a die according to the Examples.

FIG. 9 is a graph showing a total rotation rate of the die versus the position a die according to the Examples.

FIG. 10 is a graph showing a tailstock force versus the position of a die according to the Examples.

FIG. 11 is a graph showing a total travel rate versus the position of a die according to the Examples.

FIG. 12 is a graph showing the optimal length of the landing of a die based on the measured steady state force and tool rotation rate according to the Examples.

### DETAILED DESCRIPTION OF THE INVENTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “weight-average molecular weight” as used herein refers (M_{w}), which is equal to ΣMᵢ²nᵢ/ΣMᵢnᵢ, where nᵢ is the number of molecules of molecular weight Mᵢ. In various examples, the weight average molecular weight can be determined using light scattering, small angle neutron scattering, X-ray scattering, and sedimentation velocity.

According to various aspects of the present disclosure, an extruded polymer composite can have a relatively high filler content that exhibits physical properties that are favorable for many different applications. The extruded polymer composite is made possible using a Shear Assisted Processing and Extrusion system as described further herein.

In general, a polymer composite refers to a material combining a distinct polymer material with one or more filler components to create a substance with enhanced properties relative to a single component polymer. These materials typically include a matrix polymer and one or more filler components, which can be other polymers, flakes, fibers, or particles. The resulting composite often exhibits superior characteristics compared to its individual constituents, such as improved strength, durability, or thermal resistance.

In the instant disclosure the polymer composite includes at least a polymer matrix and a filler distributed about the polymer matrix. The polymer matrix includes a thermoplastic polymer or a mixture of thermoplastic polymers. A thermoplastic polymer is a type of plastic material that becomes pliable or moldable when heated and solidifies upon cooling, allowing it to be reshaped multiple times without significant degradation. This reversible process is due to the weak intermolecular forces between polymer chains, which break upon heating and reform upon cooling. Classes of thermoplastic polymers include polyethylene (PE), polypropylene (PP), polyvinyl chloride (PVC), polystyrene (PS), polyethylene terephthalate (PET), polyamides (nylons), polycarbonates (PC), acrylonitrile butadiene styrene (ABS), polymethacrylates (e.g., PMMA), and fluoropolymers (e.g., PTFE). Each class has unique properties and applications, ranging from packaging materials and textiles to automotive parts and electronic components. These thermoplastics can be further categorized into commodity plastics, engineering plastics, and high-performance plastics based on their properties and applications.

Within the range of thermoplastic polymers, polymers that may be well suited for the polymer matrix can include polyethylene, polypropylene, and polyvinyl chloride, or a mixture thereof. Examples of suitable polyethylenes can include high-density polyethylene (HDPE) or low-density polyethylene (LDPE). HDPE is characterized by its high strength-to-density ratio and minimal branching of polymer chains. It has a density range of about 0.941 to about 0.965 g/cm³. HDPE's structure results in stronger intermolecular forces and higher tensile strength compared to LDPE. It is commonly used in products requiring durability, such as milk jugs, detergent bottles, and pipes. LDPE, on the other hand, has a more branched structure with weaker intermolecular forces. Its density ranges from about 0.910 to about 0.940 g/cm³. LDPE is more flexible and transparent than HDPE, with lower tensile strength and higher ductility. It is often used in applications requiring flexibility, such as plastic bags, squeeze bottles, and some packaging films.

If the polymer matrix includes polypropylene, the polypropylene can be a homopolymer polypropylene or a copolymer polypropylene. Homopolymer polypropylene includes a single type of monomer (propylene) repeated throughout the polymer chain. This results in a more crystalline structure with higher stiffness, tensile strength, and hardness. It also has better chemical resistance and a higher melting point compared to copolymer polypropylene. Copolymer polypropylene, on the other hand, incorporates a small amount (e.g., about 1 to about 7%) of another monomer, usually ethylene, into the polymer chain. This creates a less regular structure, reducing crystallinity and improving impact strength, especially at low temperatures. Copolymer polypropylene is more flexible and has better transparency than homopolymer polypropylene.

As stated hereinabove, the polymer matrix can include one polymer or a mixture of different polymers. If the polymer matrix includes a mixture of polymers, the mixture can include two different polymers, three different polymers, or any plural number of different polymers. Polymers can be different in that they can be different classes of polymers (e.g., have different chemical compositions). They can also be different in that they can have the same chemical structure but differ by their weight-average molecular weight. The different polymers can be present at substantially the same amount in the polymer matrix (e.g., present at substantially the same wt %) or at a different amount (e.g., wt %) in the polymer matrix relative to at least one other polymer in the polymer matrix.

Individual polymers used in the polymer matrix can be a virgin polymer (e.g., a produced and previously unused polymer) of a recycled polymer. In some examples, the polymer matrix can include the same polymer, but it may be a mixture of the virgin and recycled versions of the polymer. In examples where the polymer matrix includes a mixture of different polymers some may be virgin polymers and some may be recycled polymers. It is possible for the recycled polymer to include some impurities, but any negative impact of any impurities on the physical properties of the extruded polymer composite (possibly due to the ShAPE extrusion method deserved further herein) is expected to be minimal.

The filler content in the extruded polymer composite is in a range of from about 65 wt % to about 90 wt % of the extruded polymer composite, about 75 wt % to about 90 wt %, about 80 wt % to about 90 wt %, less than, equal to, or greater than about 65 wt %, 66, 67, 68, 69, 70, 71, 72, 73, 74, 75, 76, 77, 78, 79, 80, 81, 82, 83, 84, 85, 86, 87, 88, 89, or about 90 wt %. The balance of the extruded polymer composite includes the polymers mentioned hereinabove or any other components.

Examples of suitable fillers can include wood flour, saw dust, glass fibers, carbon fibers, metal particles, ceramic particles, nanomaterials, coal particles, lignite, lignin, cellulose, natural fibers, cross linked polymers comprising lignin, or a mixture thereof.

Nanomaterials are generally considered to be materials with at least one external dimension measuring in a range from about 1 to about 100 nanometers (nm). These materials exhibit unique physical, chemical, and biological properties compared to their bulk counterparts due to their extremely small size and high surface area-to-volume ratio. Characteristics of nanomaterials include the aforementioned dimensions; unique properties that are different from bulk materials due to quantum effects and increased surface area; and being deliberately manufactured or produced, as opposed to naturally occurring nanoparticles. Nanomaterials can be categorized into several types including zero-dimensional nanomaterials (e.g., nanoparticles and quantum dots); one-dimensional nanomaterials (e.g., nanowires and nanotubes); two-dimensional nanomaterials (e.g., graphene and nanosheets; and three-dimensional nanomaterials (e.g., nanocomposites and bulk nanostructured materials). Generally, the nanomaterials are carbon-based materials such as carbon nanotubes or graphene but can be made with other materials also such as boron nitride, MXenes, pure metals, alloys, ceramics, semiconductors, and polymers. If the filler is lignin or wood flour, they can be derived from hardwood or softwood. Examples of lignite can include a carboxylated lignite (including, for example, about 2 Wt % CO₂ as acids), or cross linked polymers such as lignin or carboxylated lignin (including about 2 to about 4.5 Wt % CO₂ as acids.

As described herein above, the filler content can include a single type of filler of a mixture of different fillers. A mixture of fillers can include two different fillers, three different fillers, or any plural number of fillers. If multiple fillers are included, the fillers can be present in substantially the same amount (e.g., by wt %) or an amount of at least one filler can differ with respect to another filler.

As a result of the extrusion process described further herein, the filler is distributed homogenously about the polymer matrix. The filler is distributed homogenously in that it is uniformly distributed within the polymer matrix, creating a consistent structure throughout the material. A beneficial property associated with the homogenous distribution is that the material can exhibit similar properties in all directions. Moreover, the homogeneous mixture can allow for effective interaction between the filler surfaces and the polymer matrix, which can play a role in property enhancement.

In some examples, the extruded polymer composite can further include an additive such as a stabilizer, a colorant, a flame retardant, or a mixture thereof. Some illustrative examples of flame retardants include, for example, organophosphorous compounds such as organic phosphates (including trialkyl phosphates such as triethyl phosphate, tris (2-chloropropyl) phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris (diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl)-10H-9-oxa-10-phospha-phenanthrene-10-oxide, phosphorus-containing lactone-modified polyesters, ethylene glycol bis (diphenyl phosphate), neopentylglycol bis (diphenyl phosphate), amine- and hydroxyl-functionalized siloxane oligomers). These flame retardants can be used alone or in conjunction with other flame retardants.

Illustrative examples of stabilizers include antioxidants, UV stabilizers, heat stabilizers, and processing stabilizers. Antioxidants, such as hindered phenols and phosphites, protect against oxidative degradation. UV stabilizers, like benzophenones and benzotriazoles, prevent damage from ultraviolet radiation. Heat stabilizers, including metal soaps and organotin compounds, maintain polymer integrity at high temperatures. Processing stabilizers, such as phosphites and lactones, prevent degradation during manufacturing.

Illustrative examples of colorants include organic and inorganic stabilizers. Organic colorants, such as azo compounds, anthraquinones, and phthalocyanines, offer vibrant hues and high tinting strength. Inorganic pigments, like titanium dioxide, iron oxides, and carbon black, provide excellent opacity and durability. Metallic pigments, such as aluminum flakes or bronze powders, create lustrous effects. Special effect pigments, including pearlescent and interference pigments, produce unique visual properties. Nanoparticle pigments offer enhanced color strength and stability. Natural pigments derived from plants or minerals can be used for eco-friendly applications.

Relative to a polymer composite having a lower filler content that those disclosed herein, the instant polymer composite demonstrates improved mechanical properties. Examples of improved mechanical properties include increased flexural strength, flexural modulus, toughness, ultimate tensile strength, compressive strength, Young's modulus, hardness, stiffness, and the like. The mechanical properties associated with the polymer composite are at least comparable to standards required for using the polymer composite in a commercial application.

As non-limiting examples a flexural strength of the extruded polymer composite can range from about 20 MPa to about 40 MPa, about 25 MPa to about 33 MPa, less than, equal to, or greater than about 20 MPa, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, or about 40 MPa. Additionally, a flexural modulus of the extruded polymer composite can range from about 2 GPa to about 3.5 GPa, about 2.9 GPa to about 3.2 GPa, less than, equal to, or greater than about 2 GPa, 2.1, 2.2, 2.3, 2.4, 2.5, 2.6, 2.7, 2.8, 2.9, 3, 3.1, 3.2, 3.3, 3.4, or about 3.5 GPa. Both the flexural strength and flexural modulus are determined per ASTM D790. The flexural strength and flexural modulus are similar to current values of commercial decking materials, showing the suitability of the extruded polymer composites as a building material.

Additionally, the extruded polymer composites show adequate span ratings. For example, as determined per International Building Code (IBC) standards for commercial materials, the extruded polymer composites can surpass commercial product performance in their current state. Typically, flexural modulus of ˜1 GPa means that a composite board 6″×1″ and span rating 12″ can carry a live load of 100 psf per IBC standards. The disclosed extruded polymer composites, routinely show flexural modulus greater than 1 GPa, qualifying them to be decking boards per IBC. The span rating is determined by the following IBC standard. Using a threshold value of 4788 N/m2 (100 psf) [per Table 1607.1 in IBC] a maximum deflection based on serviceability is lT360, 1 is the span [per IBC Table 1604.3]. Equation for Uniform Live Load (wΔ) and maximum deflection (Δ) per Euler-Bernoulli beam theory [per Table 2306.1.4 in IBC] is shown in Equation 1.

$${w}_{Δ} = \frac{384 Δ {E}^{′}}{5 {l}^{4}} \frac{{d}^{3}}{12} \qquad Equation 1$$

Equation 2 is used for combining all wΔ and determining the span rating.

$${w}_{Δ} = \frac{384 {E}^{′}}{5 \times 360 {l}^{3}} \frac{{d}^{3}}{12} \geq 100 psf \qquad Equation 2$$

The polymer composite can be used as a for building materials in addition to decking materials, a vehicle component, a commodity, a sports equipment, for an infrastructural application, or the like. In some examples, the polymer composite can be recyclable.

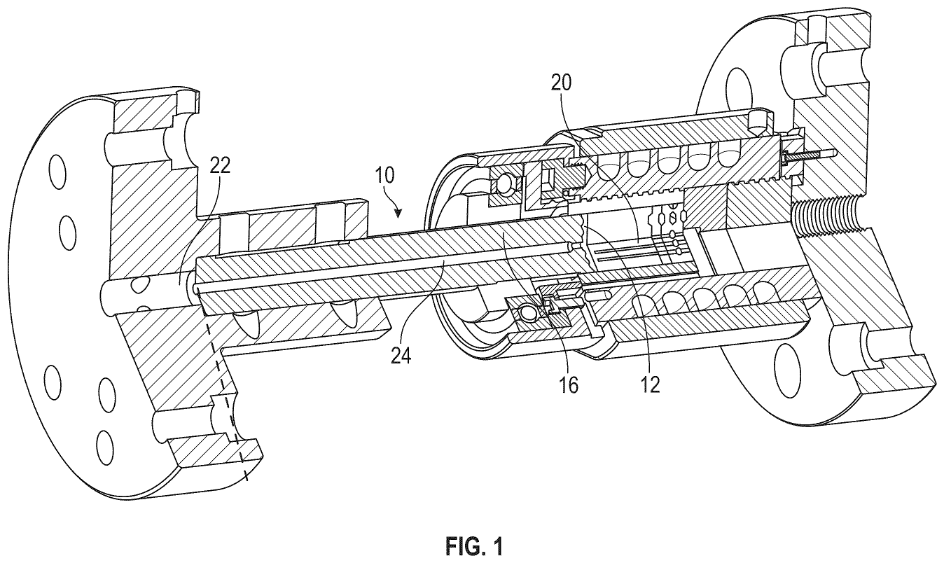

The extruded feedstock is formed using a Shear Assisted Processing and Extrusion (ShAPE) device as described further herein. As shown in FIG. 1 an example of the ShAPE device and arrangement are provided. In an arrangement such as the one shown in FIG. 1, rotating die 10 is thrust into a polymer composite feedstock located in feedstock chamber 20 under specific conditions whereby the rotating and shear forces of the die face 12 and the die body 16 combine to heat and/or plasticize the polymer composite feedstock at the interface of the die face 12 and the feedstock chamber 20 and cause the plasticized polymer composite feedstock to flow in a desired direction in either a direct or indirect manner (in other embodiments the feedstock chamber 20 may spin and the die 10 may be pushed axially into the feedstock chamber 20 so as to provide this combination of forces). The distance that the rotating die 10 is thrusted into the feedstock can be referred to as a travel distance. In either instance, the combination of the axial and the rotating forces plasticize the polymer composite feedstock held in the feedstock chamber 20 at the interface with the die face 12. The polymer composite feedstock is a compacted billet feedstock of a polymer (which becomes the polymer matrix) and the filler as well as any other additives. These components are not homogenized prior to extrusion.

Flow of the plasticized polymer composite feedstock can then be directed to another location wherein a die bearing surface 24 of a preselected length facilitates the recombination of the plasticized polymer composite feedstock into an arrangement wherein a new and more homogenization of at least the polymer and filler can take place. This then translates to an extruded product at exit 22 with the aforementioned desired characteristics. The extruded product at exit 22 can be in the form of a substantially rounded wire, a ribbon, a triangular rod, a quadrilateral rod, or other polygonal rod. This arrangement also provides for a methodology for performing other steps such as cladding, enhanced control for through wall thickness and other characteristics, joining of dissimilar materials and tolerating a higher filler content than would be reasonably expected in a polymer composite.

This arrangement is distinct from and provides a variety of advantages over the conventional methods for extrusion. First, during the extrusion process the force rises to a peak in the beginning and then falls off once the extrusion starts. This is called breakthrough.

In ShAPE the breakthrough force can be mitigated or eliminated by a combination of 1) the die features and rotation thereof funnel polymer composite feedstock into the throat, 2) heat generation at the die-feedstock interface warms the die throat allowing for the extrudate to flow through without substantial cooling, 3) the active and independently controllable rotation and thrust allow a gradual increase to the extrusion speed at the beginning of the extrusion. These effects, mitigating or eliminating the breakthrough force, can allow for a similar machine to extrude larger feedstocks and extrudate products, and can lessen peak stresses in the die which can prolong die life.

The ShAPE process is significantly different than conventional extrusion means such as normal extrusion, hot-extrusion, polymer extrusion, compression molding, injection molding or Friction Stir Back Extrusion (FSBE). In FSBE, a spinning mandrel, sometimes called a tool, is rammed into a contained billet, much like a drilling operation. Scrolled grooves force polymer composite feedstock outward and polymer composite feedstock back extrudes around and onto the mandrel to form a tube, not having been forced through a die. As a result, only very small extrusion ratios are possible in FSBE, the tube is not fully processed through the wall thickness, the extrudate is not able to push off of the mandrel, and the tube length is limited to the extended length of the mandrel. In contrast, ShAPE utilizes spiral grooves (or other features) on a die face to feed polymer composite feedstock inward through a die and (optionally for hollow-centered profiles) around a mandrel that is traveling in the same direction as the extrudate. As such, a much larger outer diameter and extrusion ratio are possible, the polymer composite feedstock is uniformly processed through the wall thickness, the extrudate is free to push off the mandrel as in conventional extrusion, and the extrudate length is only limited only by the starting volume of the billet. ShAPE can be scalable to the manufacturing level, while the limitations of FSBE have kept the technology as a non-scalable academic interest since FBSE was first reported.

The ShAPE process has been utilized to form various structures from a variety of materials. In the previously described and related applications various methods and techniques are described wherein the ShAPE technique and device can provide a number of advantages including the ability to control microstructure through the cross-sectional thickness, while also providing the ability to perform various other tasks.

Generally, in shear-assisted extrusion techniques as shown and described herein (such as in relation to the apparatus of FIG. 1), both a linear axial force and a rotational shear force are simultaneously applied to a material of interest causing the material to heat and plasticize. In extrusion applications, the plasticized material then flows over a die bearing surface dimensioned so as to allow recombination of the plasticized materials in an arrangement with superior grain size distribution and alignment than what is possible in traditional extrusion processing. As described in the prior related applications this process can provide a number of advantages and features that conventional prior art extrusion processing is simply unable to achieve. ShAPE processing also supports extrusion a variety of different shapes and internal profiles, including circular, solid, hollow (e.g., using a mandrel).

The mixture of materials to be extruded is not pre-heated before introduction into the die 10. This is unique as typically extruding a high filler content mixture would need to be heated to reduce before entering an extrusion system in order to mitigate the risk of clogging the system. ShAPE does not carry the same risk. Indeed the mixture 20 can simply be mixed by hand or mechanical means, melt compounded, or compacted to form a billet. A fixed amount of feedstock can be introduced if extrusion is carried out in a batch mode or the feedstock can be continuously fed to the die 10. A feed rate of the mixture 20 into ShAPE can be carefully controlled to mitigate against clogging. For example, a feed rate of the mixture can be in a range of from about 4 mm/min to about 50 mm/min, about 5 mm/min to about 15 mm/min, less than, equal to, or greater than about 4 mm/min, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 mm/min.

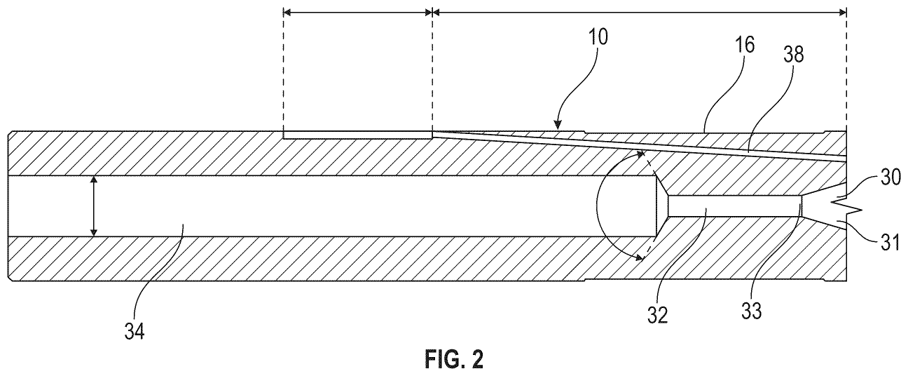

The die 10 is designed to accommodate the high load of filler and mitigate against the tendency of the mixture to clog during extrusion. In some examples, the die 10 can be retrofitted to an extrusion device. The die 10 is shown in FIG. 1 and shown in more detail in FIG. 2, which is a sectional view of the die 10. As shown in FIG. 2, the die 10 includes the shank or the body 16. The body 16 defines the die face 12 at a first end of the die 10 to engage the polymer composite feedstock in the feedstock chamber 20. The die face 12 can be substantially smooth or flat. Alternatively, all or a portion of the die face 12 can have a series of three dimensional features such as grooves or projections that can be arranged as a spiral, this is referred to as scroll face. An outer cross-sectional profile of the body 16 is substantially cylindrical. The body 16 of the die 10 can be formed from steel, titanium, a ceramic, or a mixture thereof.

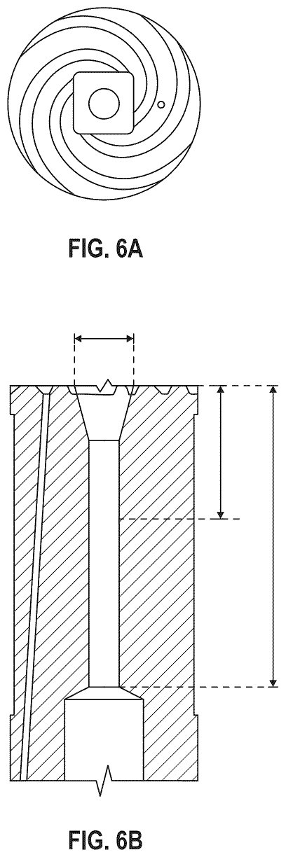

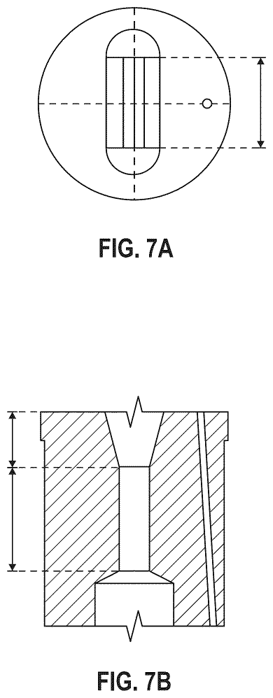

The body 16 includes a neck section 30. The neck section 30 defines a passage from an opening in the die face 12 through which plasticized polymer composite feedstock is extruded. The neck section 30 has a generally frustum cross-sectional profile. More specifically, the neck section 30 extends axially between a first end 31 and a second end 33. The cross-sectional profile of the first end 31 and the second end 33 can be substantially the same. For example, both the first end 31 and the second end 33 can be circular or polygonal. Or the cross-sectional profile of the first end 31 and the second end 33 can be different. For example, as shown in the Examples herein the first end 31 can have a substantially square or rectangular cross-sectional profile (in each case one or more corners can be rounded) while the second end 33 can be rounded or substantially rectangular. The cross-sectional profile of the neck section 30 helps to provide an easy flow of materials before entering into the landing lection 32. Moreover, the cross-sectional profile of the neck section 30 can help to provide effective consolidation of the desired geometric shape of the extruded polymer composite. For example, to make a circular bar, neck section 30 can have a square shape first end 31 (FIG. 6A) or in case of ribbon, first end 31 can have an oval shape (FIG. 7A).

After encountering the neck section 30, the extruded polymer composite passes to a landing section 32. The landing section 32 defines a cross-sectional profile of the extruded polymer composite. A length of the landing section 32, measured in an axial direction, is in a range of from about 0.05 cm to about 20 cm, about 1 cm to about 4 cm, less than, equal to, or greater than about 0.05 cm, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, 14.1, 14.2, 14.3, 14.4, 14.5, 14.6, 14.7, 14.8, 14.9, 15, 15.1, 15.2, 15.3, 15.4, 15.5, 15.6, 15.7, 15.8, 15.9, 16, 16.1, 16.2, 16.3, 16.4, 16.5, 16.6, 16.7, 16.8, 16.9, 17, 17.1, 17.2, 17.3, 17.4, 17.5, 17.6, 17.7, 17.8, 17.9, 18, 18.1, 18.2, 18.3, 18.4, 18.5, 18.6, 18.7, 18.8, 18.9, 19, 19.1, 19.2, 19.3, 19.4, 19.5, 19.6, 19.7, 19.8, 19.9, or about 20 cm. A cross-sectional width or diameter of the landing section 32, measured in a radial direction, is in a range of from about 0.05 cm to about 10 cm, about 0.3 cm to about 0.7 cm, less than, equal to, or greater than 0.05 cm, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10. These values can change depending on the desired diameter of the extruded polymer composite, they are not intended to be limiting.

After passing through the landing section 32, the extruded polymer composite passes to release section 34. The cross-sectional width or diameter of the landing section 32 is less than a cross-sectional width or diameter of the release section 34 in the same axis. A cross-sectional profile of the release section 34 is quadrilateral or circular. The die 10 terminates at the end 36 of the release section, which terminates in an elongate opening or a circular opening. The overall shape of the extruded polymer composite is a function of the shape of the release section 34 and end 36.

The die 10 can include a temperature control element to detect or regulate a temperature within the die 10. The temperature control element can be positioned in the passage 38. Further sensors such as those for monitoring parameters such as, pressure, rotational speed or a combination thereof can also be included in the die 10 and potentially positioned in the passage 38. Temperature is generally controlled or modulated to prevent degradation of the polymer and the filler. In general, the die 10 is not heated beyond a melting temperature of at least one of the filler components.

The shape of the die 10 (e.g., shape of the neck section 30, the landing 32, the release section 34, or a combination of at least two thereof) contribute to the relative lack of clogging of the feedstock. Additionally the rate that the die 10 is rotated contributes to the lack of clogging. To that end, the die 10 is rotated at a speed sufficient to generate shear forces that prevent agglomeration of the filler. For example, a rotation rate of a die 10 can be in a range of from about 3 RPM to about 60 RPM, about 6 RPM to about 21 RPM, less than, equal to, or greater than about 3 RPM, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or about 60 RPM. Rotation a force is generally driven by a shank of the body 10 having one or more features configured to be engaged by a chuck that drives rotation.

The rotational force allows for a comparatively lower axial force to be applied compared to a method that that does not include imparting the rotational force. The lower axial force helps to control the rate that the feedstock is fed through the body 10 and therefore help prevent clogging. Together the axial force and the rotational force are applied to extrude the mixture through an opening of the die.

### EXAMPLES

The following Example is intended to illustrate an aspect of the disclosure, the disclosure is not limited by this section.

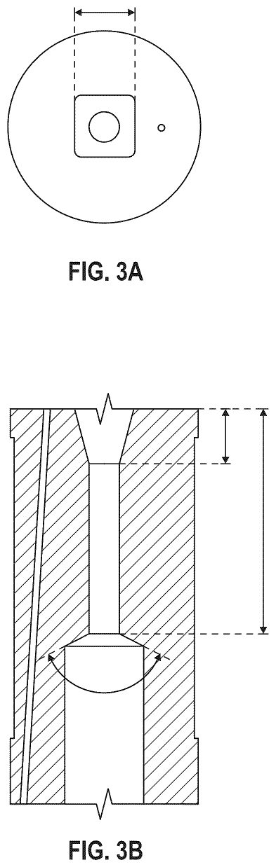

Five dies were fabricated. The five dies are shown in FIGS. 3A-7B. FIGS. 3A and 3B show Die 1, FIG. 3A is a view of the die face of Die 1 and FIG. 3B is a sectional view of Die 1. Die 1 has a smooth or flat die face, a first end of the neck section has a square cross-sectional profile having a width of 0.5 cm, and a second end of the neck section is circular having a diameter of 5 mm. A length of the neck section is 0.7 cm. A length of the landing is 3.81 cm.

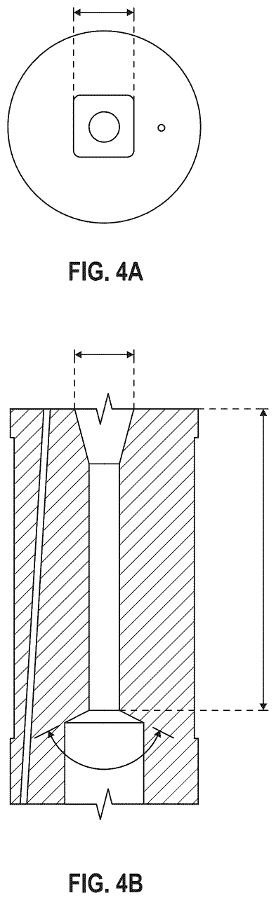

FIGS. 4A and 4B show Die 2, FIG. 3A is a view of the die face of Die 2 and FIG. 4B is a sectional view of Die 2. Die 2 has a smooth or flat die face, a first end of the neck section has a square cross-sectional profile having a width of 0.5 cm, and a second end of the neck section is circular having a diameter of 5 mm. A length of the neck section is 0.7 cm. A length of the landing is 0.5 cm.

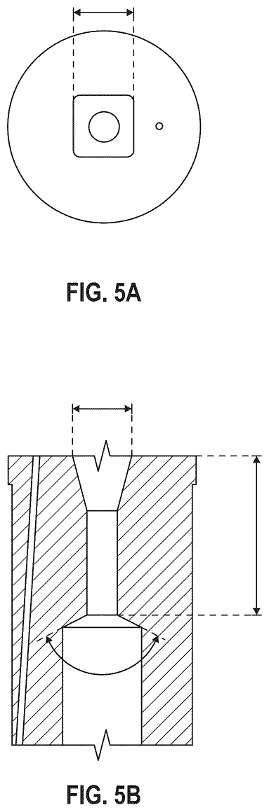

FIGS. 5A and 5B show Die 3, FIG. 5A is a view of the die face of Die 3 and FIG. 5B is a sectional view of Die 3. Die 3 has a smooth or flat die face, a first end of the neck section has a square cross-sectional profile having a width of 0.5 cm, and a second end of the neck section is circular having a diameter of 5 mm. A length of the neck section is 0.7 cm. A length of the landing is 2.5 cm.

FIGS. 6A and 6B show Die 4, FIG. 6A is a view of the die face of Die 4 and FIG. 6B is a sectional view of Die 4. Die 4 has a scroll die face, a first end of the neck section has a square cross-sectional profile having a width of 0.5 cm, and a second end of the neck section is circular having a diameter of 5 mm. A length of the neck section is 0.7 cm. A length of the landing is 5 cm.

FIGS. 7A and 7B show Die 5, FIG. 7A is a view of the die face of Die 5 and FIG. 7B is a sectional view of Die 5. Die 5 has a smooth or flat die face, a first end of the neck section has rectangular cross-sectional profile with rounded edges having a width of 0.3 cm and a length of 1.2 cm. A second end of the neck section is rectangular having a width of 3 mm and a length of 12.7 mm. A length of the neck section is 0.5 cm. A length of the landing is 2.6 cm.

Each of Dies 1-5 were used to form an extruded polymer composite. The feedstock included a mixture of lignite filler and high-density polyethylene billeted into pellets. Parameters of forming the extruded polymer composite are shown in Table 1.

| | | | Cold | Extrusion | |
|---|---|---|---|---|---|
| | Filler | Billet | Compaction | System | Feed |
| | Content | Weight | Force | Temperature | Rate |
| Die | (wt %) | (g) | (kN) | (° C.) | (mm/min) |
| 1 | 81 | 51.1 | 150 | 140 | 10 |
| 2 | 82 | 52.6 | 150 | 142 | 10 |
| 3 | 83 | 52.8 | 150 | 140 | 10 |
| 4 | 84 | 52.1 | 150 | 135 | 10 |
| 5 | 85 | 51.9 | 150 | 135 | 10 |

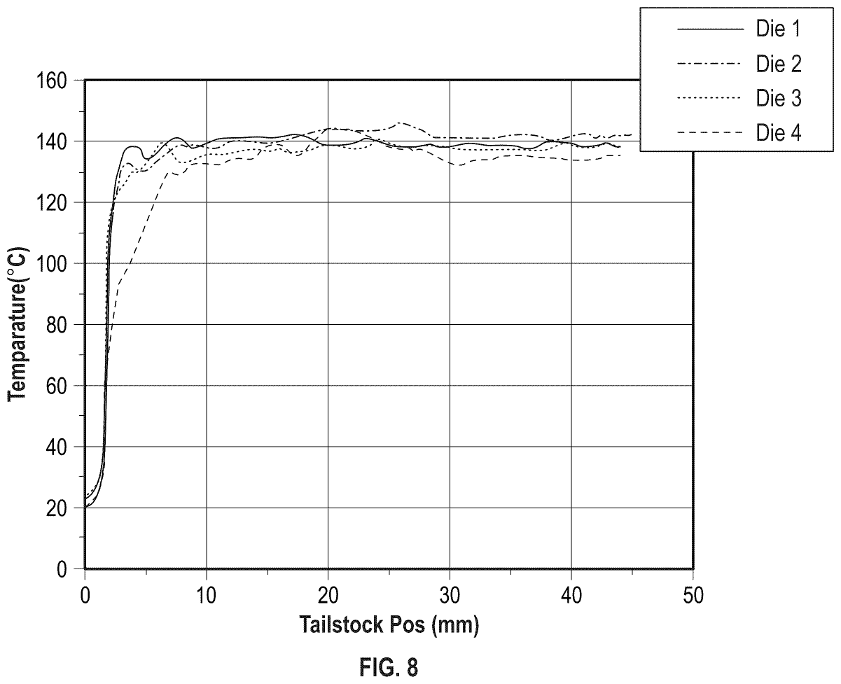

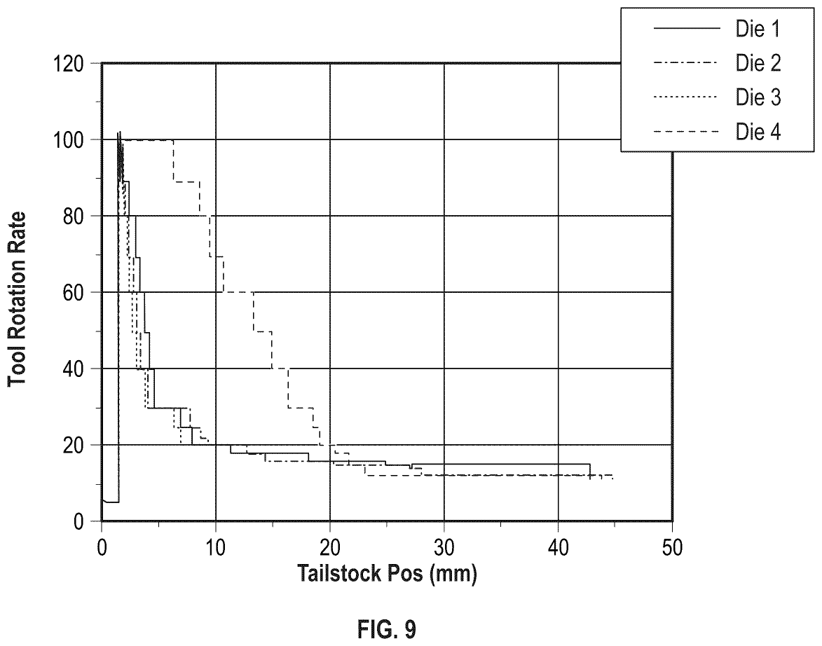

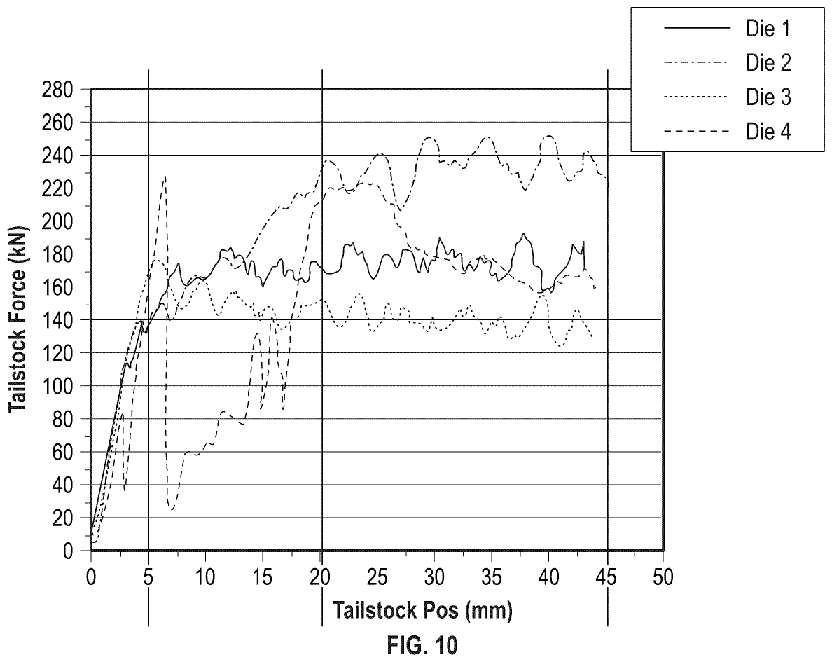

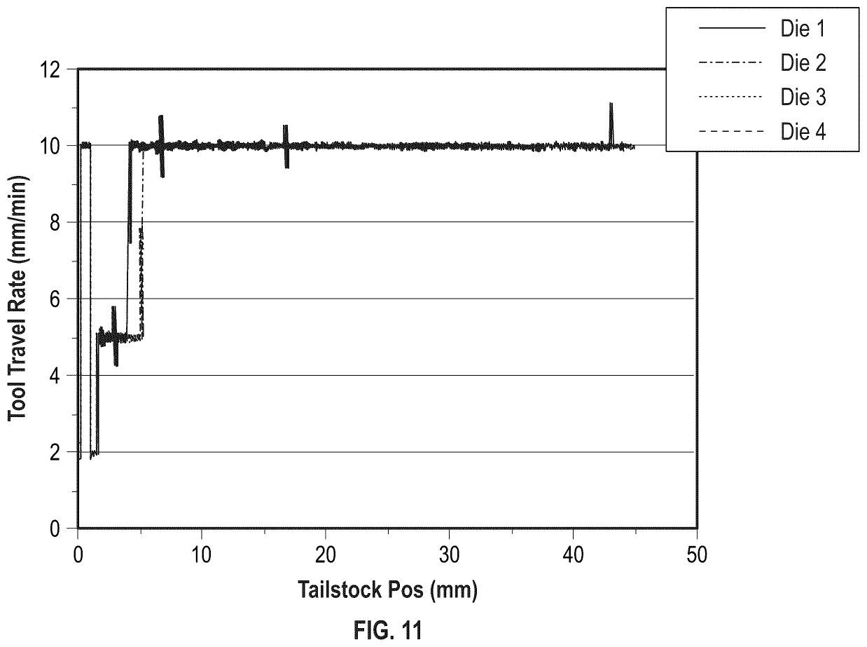

FIGS. 8-11 graphs showing a measured extrusion system temperature, die rotation rate, tailstock force, and tool travel rate versus the position of the die as it moves into the feedstock (0 mm being the starting position)

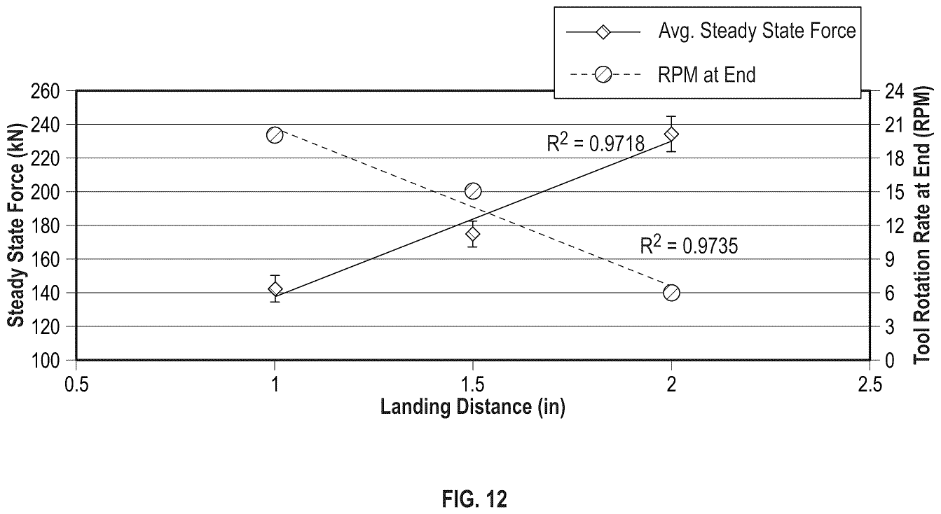

FIG. 12 is a graph showing the results of a parametric study to determine the optimal length of the landing based on the measured steady state force and tool rotation rate. It was found that a length of 1.5 inches (3.81 cm) for the landing was the optimum length for extruding the polymer composite shaped as a 5 mm diameter round bar.

### Exemplary Aspects

The following exemplary aspects are provided, the numbering of which is not to be construed as designating levels of importance:
Aspect 1 provides an extruded polymer composite comprising:
a polymer matrix, comprising a virgin polymer, recycled polymer, or a mixture thereof;
and a filler content greater than about 65 wt % homogenously distributed about the polymer matrix.
Aspect 2 provides the extruded polymer composite of Aspect 1, wherein the polymer matrix comprises a thermoplastic polymer or a mixture of thermoplastic polymers.
Aspect 3 provides the extruded polymer composite of Aspect 2, wherein the thermoplastic polymer comprises a polyolefin.
Aspect 4 provides the extruded polymer composite of Aspect 3, wherein the thermoplastic polymer comprises polyethylene, polypropylene, and polyvinyl chloride, or a mixture thereof.
Aspect 5 provides the extruded polymer composite of any of Aspects 3 or 4, wherein the thermoplastic polymer is polyethylene.
Aspect 6 provides the extruded polymer composite of any of Aspects 4 or 5, wherein the polyethylene is high-density polyethylene (HDPE).
Aspect 7 provides the extruded polymer composite of any of Aspects 4 or 5, wherein the polyethylene is low-density polyethylene (LDPE).
Aspect 8 provides the extruded polymer composite of any of Aspects 2-7, wherein the thermoplastic polymer is polypropylene.
Aspect 9 provides the extruded polymer composite of Aspect 8, wherein the polypropylene is a homopolymer polypropylene or a copolymer polypropylene.
Aspect 10 provides the extruded polymer composite of any of Aspects 1-9, wherein the filler comprises wood flour, saw dust, glass fibers, carbon fibers, metal particles, ceramic particles, nanomaterials, coal particles, lignite, lignin, cellulose, natural fibers, cross linked polymers comprising lignin, or a mixture thereof.
Aspect 11 provides the extruded polymer composite of Aspect 10, wherein the nanomaterials comprise carbon nanotubes, graphene, or a mixture thereof.
Aspect 12 provides the extruded polymer composite of any of Aspects 1-11, wherein the filler content greater than about 75 wt % in the polymer matrix.
Aspect 13 provides the extruded polymer composite of any of Aspects 1-12, wherein the filler content greater than about 80 wt % in the polymer matrix.
Aspect 14 provides the extruded polymer composite of any of Aspects 1-13, wherein the filler content greater in a range of from about 75 wt % to about 90 wt % of the polymer matrix.
Aspect 15 provides the extruded polymer composite of any of Aspects 1-14, wherein the filler content greater in a range of from about 80 wt % to about 90 wt % of the polymer matrix.
Aspect 16 provides the extruded polymer composite of any of Aspects 1-15, wherein the composite demonstrates improved mechanical properties compared to composites with lower filler content.
Aspect 17 provides the extruded polymer composite of Aspect 16, wherein the improved mechanical properties comprise increased stiffness.
Aspect 18 provides the extruded polymer composite of any of Aspects 1-17, wherein the composite is suitable for applications comprising building materials, vehicle components, commodities, sports equipment, and infrastructural applications.
Aspect 19 provides the extruded polymer composite of any of Aspects 1-18, wherein the composite is manufactured to match market equivalent production levels.
Aspect 20 provides the extruded polymer composite of any of Aspects 1-19, wherein the composite is recyclable.
Aspect 21 provides the extruded polymer composite of any of Aspects 1-20, wherein the composite comprises an additives comprising a stabilizer, a lubricant, a colorant, a flame retardant, or a mixture thereof.
Aspect 22 provides the extruded polymer composite of any of Aspects 1-21, wherein the filler comprises wood flour.
Aspect 23 provides the extruded polymer composite of Aspect 22, wherein the wood flour is derived from hardwood.
Aspect 24 provides the extruded polymer composite of Aspect 22, wherein the wood flour is derived from softwood.
Aspect 25 provides the extruded polymer composite of Aspect and of Aspects 1-24, wherein the filler comprises carbon nanotubes.
Aspect 26 provides the extruded polymer composite of Aspect 25, wherein the carbon nanotubes are multi-walled carbon nanotubes.
Aspect 27 provides the extruded polymer composite of Aspect 25, wherein the carbon nanotubes are single-walled carbon nanotubes.
Aspect 28 provides a method for manufacturing a polymer composite, the method comprising:
introducing a feedstock comprising a mixture of a polymer component and a filler component into a container; and
establishing an axial force and a rotational force at a face of a die engaged with the feedstock to establish shear to homogenize the mixture including distributing the filler homogeneously within a matrix of the polymer component, wherein the polymer component comprises a virgin polymer, recycled polymer, or a mixture thereof.
Aspect 29 provides the method of Aspect 28, wherein the polymer component comprises a thermoplastic polymer or a mixture of thermoplastic polymers.
Aspect 30 provides the method of any of Aspect 29, wherein the thermoplastic polymer comprises polyethylene, polypropylene, polyvinyl chloride, or a mixture thereof.
Aspect 31 provides the method of Aspect 30, wherein the thermoplastic polymer is polyethylene.
Aspect 32 provides the method of Aspect 31, wherein the polyethylene is high-density polyethylene (HDPE) or low-density polyethylene (LDPE).
Aspect 33 provides the method of Aspect 30, wherein the thermoplastic polymer is polypropylene.
Aspect 34 provides the method of Aspect 33, wherein the polypropylene is a homopolymer polypropylene.
Aspect 35 provides the method of Aspect 33, wherein the polypropylene is a copolymer polypropylene.
Aspect 36 provides the method of any of Aspects 28-35, wherein the filler comprises wood flour, saw dust, glass fibers, carbon fibers, metal particles, ceramic particles, nanomaterials, coal particles, lignite, lignin, cellulose, natural fibers, cross linked polymers comprising lignin, or a mixture thereof.
Aspect 37 provides the method of Aspect 36, wherein the nanomaterials comprise carbon nanotubes, graphene, or a mixture thereof.
Aspect 38 provides the method of any of Aspects 28-37, wherein a filler content greater than about 65 wt % in the polymer matrix.
Aspect 39 provides the method of any of Aspects 28-38, wherein a filler content greater than about 75 wt % in the polymer matrix.
Aspect 40 provides the method of any of Aspects 28-39, wherein a filler content greater than about 80 wt % in the polymer matrix.
Aspect 41 provides the method of any of Aspects 28-40, wherein a filler content greater in a range of from about 65 wt % to about 90 wt % of the polymer matrix.
Aspect 42 provides the method of any of Aspects 28-41, wherein a filler content greater in a range of from about 75 wt % to about 90 wt % of the polymer matrix.
Aspect 43 provides the method of any of Aspects 28-42, wherein a filler content greater in a range of from about 80 wt % to about 90 wt % of the polymer matrix.
Aspect 44 provides the method of any of Aspects 28-43, wherein the die is rotated at a speed sufficient to generate shear forces that prevent agglomeration of the filler.
Aspect 45 provides the method of any of Aspects 28-44, further comprising controlling a temperature during the method to prevent degradation of the polymer and the filler.
Aspect 46 provides the method of any of Aspects 28-45, wherein the axial force and the rotational force are applied corresponding to a shear-assisted extrusion approach to extrude the mixture through an opening of the die.
Aspect 47 provides the method of any of Aspects 28-46, wherein the mixture is not pre-heated before introduction into the die.
Aspect 48 provides the method of any of Aspects 28-47, wherein the method does not require external heating of the polymer prior to extrusion.
Aspect 49 provides the method of any of Aspects 28-48, wherein the polymer and filler are physically mixed before introduction into the die.
Aspect 50 provides the method of any of Aspects 28-49, wherein the polymer and filler are melt compounded before introduction into the die.
Aspect 51 provides the method of any of Aspects 28-50, wherein the polymer and filler are compacted to form a billet before introduction into the die.
Aspect 52 provides the method of any of Aspects 28-51, wherein the rotating die is configured to modulate extrusion temperature to ensure minimal thermal degradation.
Aspect 53 provides the method of any of Aspects 28-52, wherein the rotating die is not heated beyond a melting temperature of at least one of the filler components.
Aspect 54 provides the method of any of Aspects 28-53, wherein the method includes a step of cooling the composite after formation.
Aspect 55 provides the method of any of Aspects 28-54, wherein the filler comprises wood flour.
Aspect 56 provides the method of Aspect 55, wherein the wood flour is pre-treated with a binding agent to enhance dispersion within the polymer matrix.
Aspect 57 provides the method of any of Aspects 28-56, wherein the filler comprises carbon nanotubes.
Aspect 58 provides the method of Aspect 57, wherein the carbon nanotubes are functionalized to improve compatibility with the polymer matrix.
Aspect 59 provides the method of any of Aspects 28-58, wherein a feed rate of the mixture is in a range of from about 4 mm/min to about 50 mm/min.
Aspect 60 provides the method of any of Aspects 28-59, wherein a feed rate of the mixture is in a range of from about 5 mm/min to about 15 mm/min.
Aspect 61 provides the method of any of Aspects 28-60, wherein a rotation rate of a die used for extrusion is in a range of from about 3 RPM to about 60 RPM.
Aspect 62 provides the method of any of Aspects 28-61, wherein a rotation rate of a die used for extrusion is in a range of from about 6 RPM to about 21 RPM.
Aspect 63 provides the method of any of Aspects 28-62, wherein the rotational force provided by a rotational component allows for a comparatively lower axial force to be applied compared to a method that that does not include imparting the rotational force.
Aspect 64 provides a die for use in manufacturing an extruded polymer composite, the die comprising:
a body defining a face configured to engage a polymer composite feedstock comprising a mixture of polymer and filler, the body comprising:
   a neck section defining a passage from an opening in the die face through which plasticized polymer composite feedstock is extruded, to a landing section that defines a cross sectional profile of the extruded polymer composite; and
   a release section, wherein a cross-sectional width or diameter of the landing section is less than a cross-sectional width or diameter of the release section in the same axis.
Aspect 65 provides the die of Aspect 64, wherein the release section terminates in an elongate opening or a circular opening.
Aspect 66 provides the die of any of Aspects 64 or 65, wherein a length of the landing section, measured in an axial direction, is in a range of from about 0.5 cm to about 5 cm.
Aspect 67 provides the die of any of Aspects 64-66, wherein an outer cross-sectional profile of the body is substantially cylindrical.
Aspect 68 provides the die of any of Aspects 64-67, wherein the body comprises a shank defining one or more features configured to be engaged by a chuck.
Aspect 69 provides the die of any of Aspects 64-68, further comprising a temperature control element to one or more of detect or regulate a temperature within the die.
Aspect 70 provides the die of any of Aspects 64-69, wherein the die is comprises steel, titanium, a ceramic, or a mixture thereof.
Aspect 71 provides the die of any of Aspects 64-70, wherein a cross-sectional profile of the release section is quadrilateral or circular.
Aspect 72 provides the die of any of Aspects 64-71, wherein feedstock is housed in a billet container for holding the mixture before and during application of shear forces.
Aspect 73 provides the die of any of Aspects 67-72, wherein the die is configured to operate in a continuous or batch mode.
Aspect 74 provides the die of any of Aspects 64-73, wherein the die includes sensors for monitoring parameters comprising temperature, pressure, rotational speed or a combination thereof.
Aspect 75 provides the die of any of Aspects 64-74, wherein the die is able to be retrofit to an existing machine.

What is claimed is:

1. An extruded polymer composite comprising:
a polymer matrix, comprising a virgin polymer, recycled polymer, or a mixture thereof;
and a filler content greater than about 65 wt % homogenously distributed about the polymer matrix.

2. The extruded polymer composite of claim 1, wherein the polymer matrix comprises a thermoplastic polymer or a mixture of thermoplastic polymers.

3. The extruded polymer composite of claim 2, wherein the thermoplastic polymer comprises a polyolefin.

4. The extruded polymer composite of claim 1, wherein the filler comprises wood flour, saw dust, glass fibers, carbon fibers, metal particles, ceramic particles, nanomaterials, coal particles, lignite, lignin, cellulose, natural fibers, cross linked polymers comprising lignin, or a mixture thereof.

5. The extruded polymer composite of claim 4, wherein the nanomaterials comprise carbon nanotubes, graphene, or a mixture thereof.

6. The extruded polymer composite of claim 1, wherein the filler content greater in a range of from about 75 wt % to about 90 wt % of the polymer matrix.

7. The extruded polymer composite of claim 1, wherein the filler content greater in a range of from about 80 wt % to about 90 wt % of the polymer matrix.

8. The extruded polymer composite of claim 1, wherein the composite is suitable for applications comprising building materials, vehicle components, commodities, sports equipment, and infrastructural applications.

9. The extruded polymer composite of claim 1, wherein the filler comprises wood flour.

10. A method for manufacturing a polymer composite, the method comprising:
introducing a feedstock comprising a mixture of a polymer component and a filler component into a container; and
establishing an axial force and a rotational force at a face of a die engaged with the feedstock to establish shear to homogenize the mixture including distributing the filler homogeneously within a matrix of the polymer component, wherein the polymer component comprises a virgin polymer, recycled polymer, or a mixture thereof.

11. The method of claim 10, wherein the polymer component comprises a thermoplastic polymer or a mixture of thermoplastic polymers.

12. The method of claim 10, wherein the filler comprises wood flour, saw dust, glass fibers, carbon fibers, metal particles, ceramic particles, nanomaterials, coal particles, lignite, lignin, cellulose, natural fibers, cross linked polymers comprising lignin, or a mixture thereof.

13. The method of claim 10, wherein a filler content greater in a range of from about 65 wt % to about 90 wt % of the polymer matrix.

14. The method of claim 10, wherein the polymer and filler are physically mixed before introduction into the die.

15. The method of claim 10, wherein the rotating die is not heated beyond a melting temperature of at least one of the filler components.

16. The method of claim 10, wherein a feed rate of the mixture is in a range of from about 4 mm/min to about 50 mm/min.

17. The method of claim 10, wherein a rotation rate of a die used for extrusion is in a range of from about 3 RPM to about 60 RPM.

18. A die for use in manufacturing an extruded polymer composite, the die comprising:
a body defining a face configured to engage a polymer composite feedstock comprising a mixture of polymer and filler, the body comprising:
a neck section defining a passage from an opening in the die face through which plasticized polymer composite feedstock is extruded, to a landing section that defines a cross sectional profile of the extruded polymer composite; and
a release section, wherein a cross-sectional width or diameter of the landing section is less than a cross-sectional width or diameter of the release section in the same axis.

19. The die of claim 18, wherein the release section terminates in an elongate opening or a circular opening.

20. The die of claim 18, wherein a cross-sectional profile of the release section is quadrilateral or circular.
